(19) United States
(12) Patent Application Publication
(10) Pub. No.: US 2004/0010786 A1
(43) Pub. Date: Jan. 15, 2004

(54) System and method for automatically upgrading a software application

(75) Inventors: Jamie L. Cool, Redmond, WA (US); Bradley Moore Abrams, Kirkland, WA (US); Eric K. Zinda, Seattle, WA (US)

Correspondence Address: MERCHANT & GOULD, P.O. BOX 2903, MINNEAPOLIS, MN, 55402-0903, US

(73) Assignee: Microsoft Corporation, Redmond, WA

(21) Appl. No.: 10/195,132

(22) Filed: Jul. 11, 2002

(51) Int. Cl. G06F 9/44

(52) U.S. Cl. 717/170; 717/173

(57) ABSTRACT

Described is a mechanism for enabling software applications to be upgraded from a remote location without forcing an immediate termination or restart of the application. A starter component is associated with the application such that the starter component is executed on behalf of the application. When executed, the starter component launches an executable file associated with a current version of the application. An updater component then periodically polls a remote location to determine if a newer version of the application is available for download. If so, the updater component downloads the newer version of the application to local storage. The updater component then updates configuration information such that the newer version of the application is executed on subsequent launches of the application by the application starter component.

### BACKGROUND OF THE INVENTION

Upgrading software applications that have been installed is a much more difficult process than it seems. Software developers encounter multiple problems when releasing an upgrade to a software application. One serious problem is the fear that upgrading one application may adversely affect another installed application in some unpredictable way.

Software developers commonly use shared code, such as common dialog boxes, if it makes sense to do so. For instance, very many software applications prompt the user with an open dialog box to open a file. The tasks performed may be nearly identical across the several software applications, yet each one must have access to an open dialog box. Rather than force software developers to independently create several unique dialog boxes, today those developers can use shared libraries with common code. However, if multiple applications are written that take advantage of a shared library, each becomes dependent on that shared library being available in the state in which the application expects. If one software application is upgraded and changes the shared library, that change, although unintended, could result in unpredictable behavior by another software application that references the same shared library. This circumstance has a chilling effect on the development of upgrades and is a major contributing factor in users' reluctance to perform upgrades.

Users are reluctant to install upgrades for other reasons too. Often, a user may be executing a software application connected to the Internet and is notified that an upgrade is available. Various mechanisms are currently used for notifying users of upgrades over the Internet, most commonly by a component of the application polling a server to determine whether an upgrade exists. However, most often the user is notified of the upgrade to the application because the application is currently being executed. Once the component of the application determines that there is an upgrade available, the user is prompted to decide whether to install the upgrade. If so, the user is typically presented with a user interface (UI) to download and install the upgrade. In addition, because the application was executing when the upgrade notification came in, many of the application files are open and locked, thus preventing the upgrade from being completed until the user closes and restarts the application. Most users do not appreciate being asked to close and restart an application while they are using the application. For this reason, many users simply decline the upgrade rather than be inconvenienced with the upgrade process.

These and other issues have made on-the-fly software upgrades difficult to achieve. Users have been slow to accept the simplicity of downloadable upgrades for fear (at least partially) that their existing applications will break. Software developers have been slow to offer such downloadable software out of the same fear. Existing mechanisms for downloading software upgrades have not eliminated those fears.

Nor do alternatives to downloading software upgrades seem to be achieving much acceptance in the industry. For example, the hosted application concept essentially means that applications are stored and installed on a server that is remotely accessible. A client computer can connect to the server and execute an application while only the user interface aspects of the application (e.g., keystrokes, mouse movement and clicks, and screen displays) are passed between the client computer and the server. This model completely isolates the user from the experience of upgrading most of the software applications, except the connectivity software. However, this model has not yet achieved acceptance largely because of the relative performance impact suffered from executing an application over a network. The user experience is directly tied to the bandwidth of the connection between the client and the server, and if the network fails, the hosted application is completely useless. Thus, the convenience of remotely managed software that can be upgraded easily has eluded the software community.

### SUMMARY OF THE INVENTION

The present invention is directed at enabling downloadable software upgrades to be applied to an executing application without impacting other installed applications and without necessitating an immediate restart of the executing application. Briefly stated, the present invention provides a starter component associated with the application such that the starter component is executed on behalf of the application. When executed, the starter component determines a current version of the application from configuration information. The starter component launches an executable file associated with the current version of the application. An updater component then periodically polls a remote location to determine if a newer version of the application is available for download. If so, the updater component downloads the newer version of the application to local storage. The updater component then updates the configuration information such that the newer version of the application is executed on subsequent launches of the application.

In another aspect, the newer version of the application is stored in a location different from the current version of the application. Accordingly, the different versions of the application are stored locally side-by-side. For that reason, each version of the application is isolated from the other, and may be independently executed without fear of impacting the other versions.

Advantageously, an application upgraded in accordance with the invention need not be terminated immediately after the upgrade has been performed. Because the newer version of the application is downloaded to its own location, the currently executing version of the application is unaffected. Thus, the user may continue using the current version. When the application is ultimately terminated and restarted, the newer version will be launched, thereby achieving a safe upgrade of the application without the need to immediately terminate the current version of the application.

### BRIEF DESCRIPTION OF THE DRAWINGS

FIG. 1 is a functional block diagram overview of a distributed networking environment in which implementations of the invention may be embodied.

FIG. 2 is a functional block diagram illustrating in detail an illustrative server that serves applications for installation on remote client computers, in accordance with the invention.

FIG. 3 is a functional block diagram illustrating an illustrative client computer that may retrieve and load an upgraded application from a server, in accordance with the invention.

FIG. 4 is a sample screen display of that may be presented on a client computer illustrating a shortcut or link to an application starter module, in accordance with one implementation of the invention.

FIG. 5 is a functional block diagram illustrating an illustrative client computer that may dynamically retrieve and load currently-uninstalled portions of an application from a server, in accordance with the invention.

FIG. 6 is a logical flow diagram generally illustrating a process for retrieving and installing an application that is being made available over a network.

### DETAILED DESCRIPTION OF EMBODIMENTS OF THE INVENTION

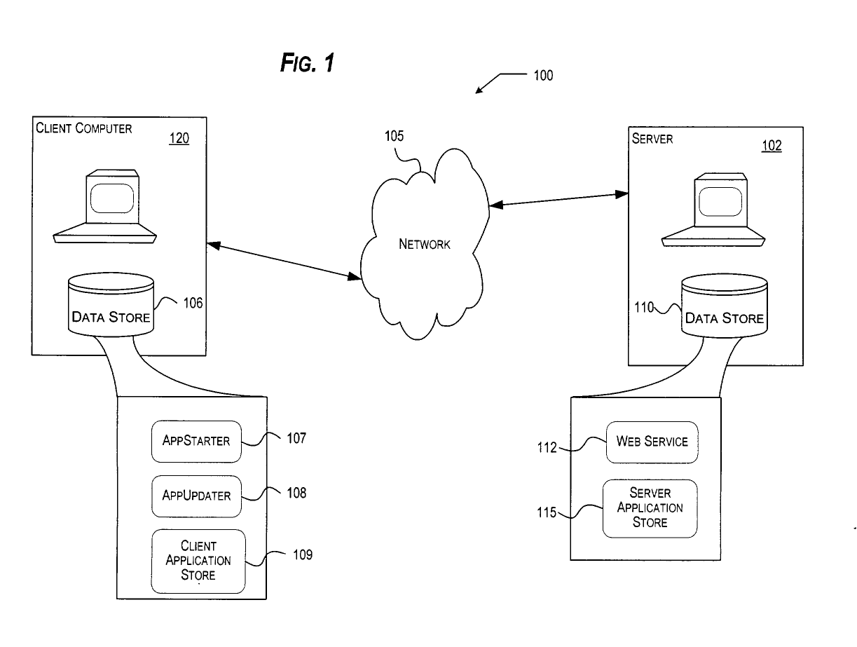

FIG. 1 is a functional block diagram overview of a distributed networking environment 100 in which implementations of the invention may be embodied. As illustrated in FIG. 1, two or more computers, such as a server 102 and a client computer 120, are connected over a network 105. The computers may be connected in a corporate environment, where the network 105 may be a local area network or a wide area network. Similarly, the computers may be arbitrarily connected over a wide area network, such as the Internet.

The server 102 is a computing system that is configured to make resources available to other computing systems connected to the network 105. The server 102 may include Web serving software to serve Internet related resources, such as HyperText Markup Language (HTML) documents, XML Web services, and the like. The server 102 includes local storage in the form of a server data store 110. On the data store 110 are at least some of the resources made available by the server 102 over the network 105. In particular, the data store 110 includes a server application store 115 for storing application code, and a Web service 112 for making upgraded application code available to other computers via the Web serving software. The functionality of the Web service 112 and the server application store 115 are described later. In this implementation, the server 102 makes application code within the server application store 115 available over the network 105 to other computing systems via the Web service 112.

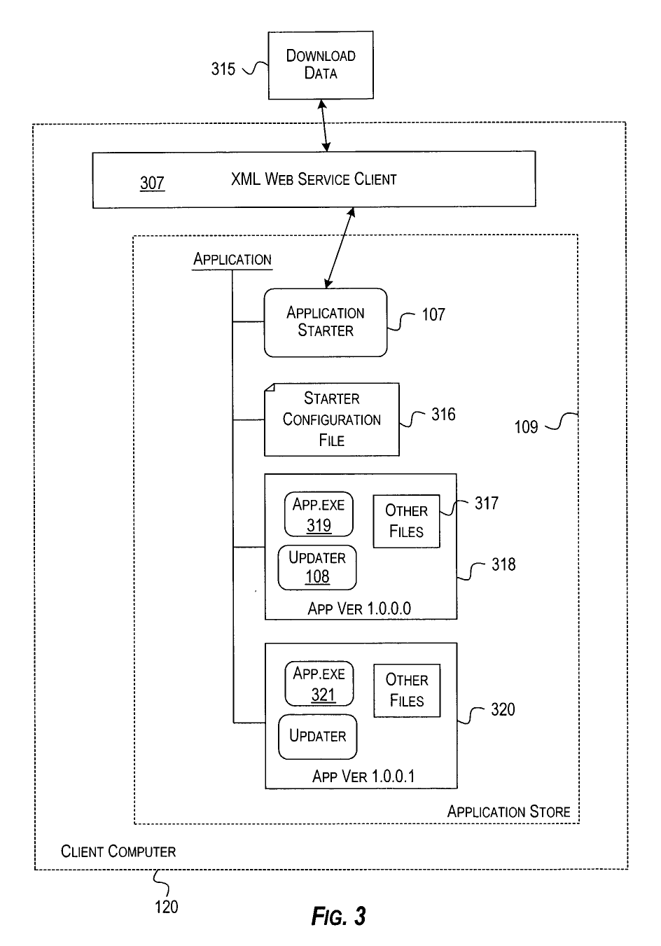

The client computer 120 is a computing system configured to execute locally-running applications as well as connect to other computers over the network 105. The client computer 120 also includes local storage in the form of a client data store 106. On the client data store 106 resides a client application store 109, an application starter 107, and an application updater 108. The client application store 109 contains locally installed application programs and any related components or modules. In accordance with the invention, the client application store 109 may contain different versions of the same application. The application starter 107 is a component associated with an application in the client application store 109 that, in conjunction with the application updater 108, enables the application to be upgraded with a new version from the server 102 in an automated and safe fashion. As will be described later in detail, upon execution, the application starter 107 essentially determines the most current version of its associated application from configuration information, and launches that version from the client application store 109. The client computer 120 may also include other applications, not shown, for interacting with other computers over the network (e.g., Internet browsing software, Web service client software, and the like) and for maintaining the client application store 109. The client computer 120 and each of its salient components will be described in greater detail below in conjunction with FIG. 3.

Briefly stated, applications are installed on the client computer 120 in any acceptable manner. For instance, the application may be downloaded from the server 102, installed from a compact disk, or the like. Once installed, the application starter 107 is used to launch an executable portion of the application. Once launched, the application updater 108 periodically connects to the server 102 in any conventional manner and queries for upgrades to the application. If found, the application updater 108 downloads the new version to the client application store 109 and installs the new version. In this way, an application may be updated at one location (e.g., on an appropriate server) and the updated application may be pushed out to many client computers.

In accordance with the invention, the new version may be installed on the client computer 120 without fear of impacting existing applications. Some computing systems today use “strong names” for each component of an application, where a strong name includes sufficient information about the component to uniquely distinguish it from other similar components. For example, the strong name of a component, such as a shared dynamic linked library, may include the version number of the component, the build number, and the like. The use of strong names allows every individual component of code to be uniquely distinguished. Thus, if the new version is installed, any existing applications will continue to depend on any shared code that existed prior to the installation of the new version, thus the installation of the new version does not impact existing applications.

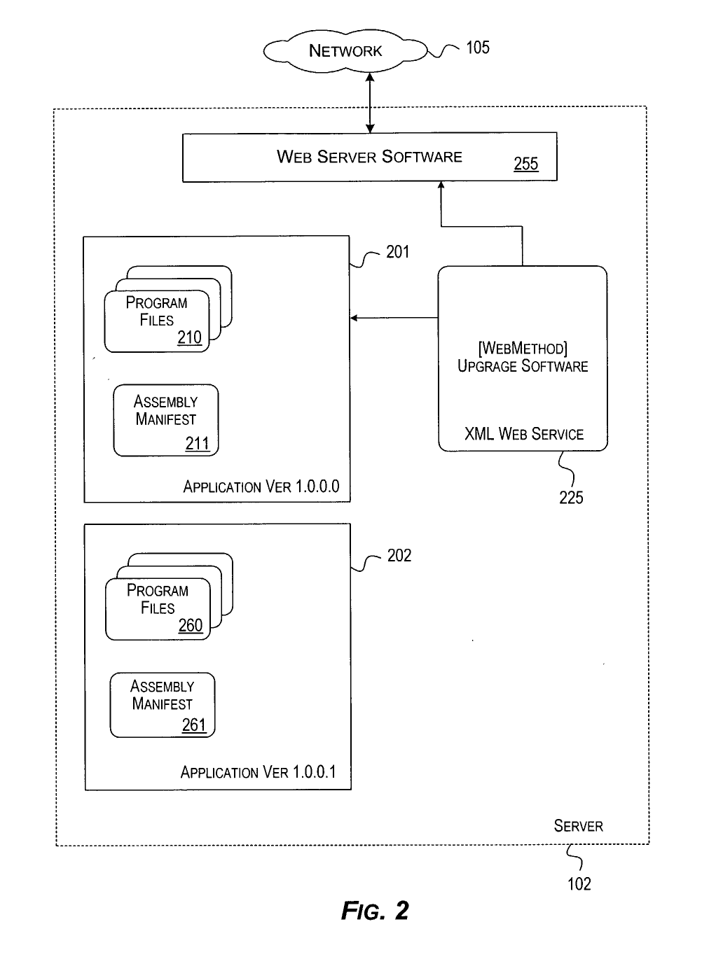

FIG. 2 is a functional block diagram illustrating in greater detail an illustrative server 102 that serves application code for installation on remote client computers, in accordance with the invention. As illustrated, the server 102 includes two versions of an application, Application Version 1.0.0.0 201, and Application Version 1.0.0.1 202. Each version of the application includes several program files (210, 260), such as executable files, configuration files, dynamically linked libraries (assemblies), and the like. As described above, components within the application may be identified by strong names, which uniquely distinguish each component from other components. Each version of the application is complete.

Each version of the application may also include an assembly manifest (211, 261). The assembly manifest (211, 261) includes information used to ensure the integrity of each component of the application. Because the application may be downloaded over a network, it is important to ensure that the components received by a requesting device are actually the components they are supposed to be. To that end, each component (or at least each executable component) of the application may be signed with a private/public key pair. Moreover, there may be more than one key used to sign the several components of the application. Accordingly, the assembly manifest 211 may include a list of the public keys that are applicable to decode each component of the application. The assembly manifest 211 may also include an exclusion list that identifies any components of the application that may be used without being signed.

An XML Web service 225 is also provided to make the versions of the application available over the network 105 and to allow clients to query for the most appropriate version of the application for their system. The XML Web service 225 includes a public method that may be invoked over the network 105 to determine whether an upgrade of the application exists. When invoked, the XML Web service 225 determines whether a newer version of the application resides on the server 102 based on information provided by the calling computer. For example, a client computer, such as client computer 120, may query whether a newer version of an application exists, and provide with the request information identifying the version of the application currently installed on the client computer. The XML Web service 225 compares the information provided with the versions of the application currently residing on the server 102. If a newer version exists, the XML Web service 225 may return it to the calling computer. In one improvement, the XML Web service 225 may consider the current load on the server 102 before returning the latest version of the application. For example, if the current number of downloads of the application exceeds some threshold, the XML Web service 225 may return that there is no newer version to force the calling computer to issue another request at a later time. The server 102 may then handle that request in the ordinary manner if it is less busy.

The Web server software 255 facilitates the interaction between remote computers and the resources on the server 102, such as the XML Web service 225. The Web server software 255 may be programmed to handle remote procedure calls in an open format, such as the Simple Object Access Protocol, or the like. The Web server software 255 may also be programmed to transmit executable files, such as program files 210, 260 and other application files over the network 105. The Web server software 255 may be configured to communicate using the HyperText Transfer Protocol (HTTP), File Transfer Protocol (FTP), or any other usable transmission protocol.

FIG. 3 is a functional block diagram illustrating in greater detail an illustrative client computer 120 that may retrieve and load applications from a server, in accordance with the invention. The client computer 120 includes an XML Web service client 307 that enables applications on the client computer 120 to issue XML Web service messages to other computers, such as the server 102, over the network. For example, an application may interact with the XML Web service client 307 to issue a request for and to download data over the network. In this implementation, the XML Web service client 307 is configured to transmit and receive messages in a format consistent with the Web server software 255 and the XML Web service 225 on the server 102.

On the application store 109 resides the components of several installed applications. In accordance with the invention, an application may include several components, such as an application starter 107, a starter configuration file 316, and one or more versions of program files associated with the installed application. In this illustration, the application store includes two versions of the program files: App Ver 1.0.0.0 318 and App Ver 1.0.0.1 320. In this implementation, each version is a complete copy of the files necessary for the application to execute. In other words, a complete copy of each installed version of the application is stored in the application store 109 separate from the other versions. In addition, an application updater 108 is associated with each version of the application. The application updater 108 is responsible for performing the functions of polling for and retrieving upgrades to the application. For simplicity of discussion, the application updater 108 is illustrated as a program separate from the main application executable (app.exe 319). However, it will be appreciated that the application updater 108 may also be included as a portion of the executable. As will be described in greater detail later, the earlier version of the application, Ver 1.0.0.0 318, may have been installed initially, and the later version, Ver 1.0.0.1 320, may have been downloaded from the server 102 at some later time.

Although illustrated in FIG. 3 as a single entity, the application store 109 may actually reside in multiple locations on the client data store 106. For example, the application store 109 may include a location where many application components are stored and another location (e.g., a global assembly cache) where shared components are stored. It should be noted that shared components stored in other locations may not be auto-updateable in the manner described here.

In accordance with the invention, the application starter 107 is used to launch instances of the application. In contrast with conventional practice, the application is not launched directly by activating a main executable program. Rather, the application starter 107 is executed when the application is invoked, and the application starter 107 is responsible for launching the main executable program. In the described embodiment, the application starter 107 is terminated when the application is terminated, or may terminate itself as soon as it has launched the application.

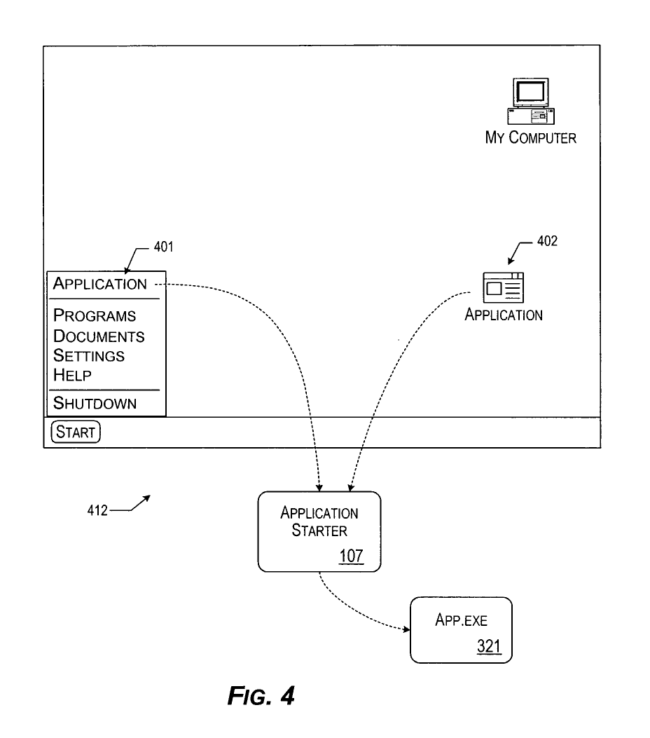

More specifically, turning briefly to FIG. 4, an example display 412 presented by the client computer 120 is shown including shortcuts for executing the application. A first shortcut 401 may reside in a collective program launching mechanism, such as a start menu or the like. A second shortcut 402 may exist in some other location, such as on a desktop or within a folder. These shortcuts both point to the application starter 107 rather than directly to the main executable application, App.exe 321 in this example. Activating either of the shortcuts (401, 402) invokes the application starter 107, which in turn invokes the main application App.exe 321.

Returning to FIG. 3, a starter configuration file 316 is provided that includes information about which version of the application to launch. More specifically, the starter configuration file 316 includes information identifying the current version of the application to be launched, and the name of the executable file to be launched (e.g., App.exe 319). Thus, when invoked, the application starter 107 can retrieve the information from the starter configuration file 316 and launch the identified version of the application.

The application updater 108 may be a component of each version of the application and is responsible for downloading and installing upgrades of the application. The application updater 108 is configured to periodically poll a predetermined location, such as the server 102, to determine whether a newer version of the application exists. The application updater 108 may operate with the XML Web service client 307 to remotely invoke a method on the server 102 to request the latest version of the application. The application updater 108 may query the server 102 when launched, at periodic time intervals while executing, or in response to some other repetitive timing. The polling period may be configured in a configuration file, or be hard coded in the application updater 108 or elsewhere.

If a newer version of the application is available, the application updater 108 may download the newer version to the application store 109. The files downloaded are stored in a separate location from the existing version of the application. As illustrated in FIG. 3, the new version of the application (i.e., App Ver 1.0.0.1 320) is stored in a folder separate from the existing version of the application (i.e., App Ver 1.0.0.0 318). Because each version of the application is stored side-by-side, the current version (which is executing) need not be terminated to complete the installation. Rather, the reference in the starter configuration file 316 to the current version is updated to reflect the new version of the application. Thus, when the application is launched again, the application starter 107 will execute the new version of the application rather than the old version. Alternatively, the user could be prompted to terminate and restart the application immediately, although this would be unnecessary and likely cause the user some inconvenience.

The cost of the download may be decreased by comparing the versions of individual components of the newer version of the application (the one to be downloaded) to existing files stored locally in conjunction with the existing version of the application. Only those files that have changed need be downloaded. Any components which have not changed from version to version may simply be copied from their current location to the location at which the new version of the application will be downloaded. Again, since component may be identified with a strong name, only those components that are identical from version to version will be copied. Even those components representing a newer build of the same version are downloaded. This ensures that the newer version of the application will function properly, and that other applications will be unaffected by the upgrade.

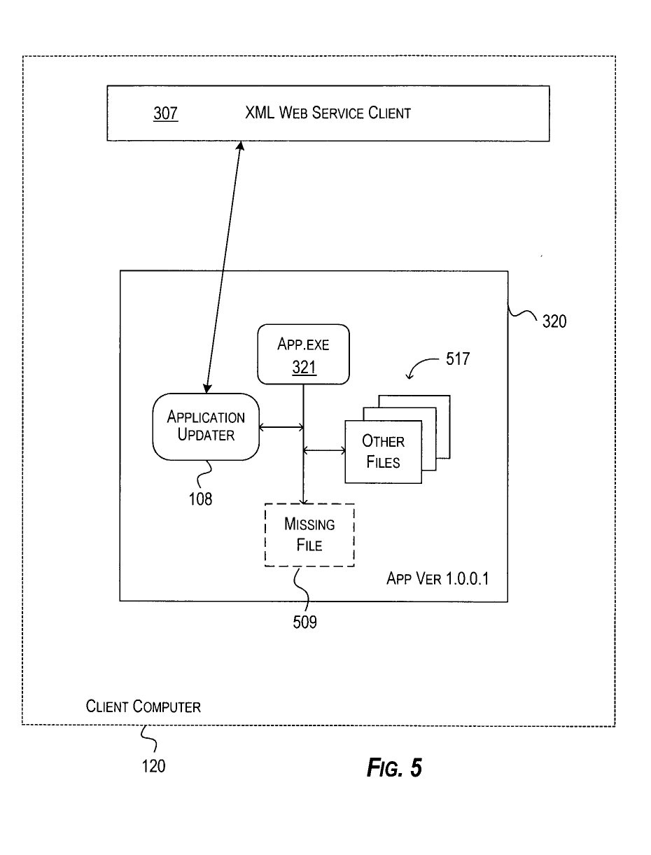

FIG. 5 is a functional block diagram generally illustrating how the present invention may be used to achieve on-demand installation of application components. As illustrated, FIG. 5 includes the application updater 108 and the later version of the application (App Ver 1.0.0.1 320). The later version includes several components of the application, such as the executable file (App.exe 321) and other files 517. However, in this implementation, a component of the application has not yet been downloaded (missing file 509). In accordance with the invention, the application updater 108 is registered to be notified in the event that one or more components of the application are determined to be missing. Thus, during execution, if one of the application files attempts to make use of the missing file 509, rather than aborting because the file is not available, the application updater 108 is notified. In response, the application updater 108 may query the same location it would for newer versions of the application, but only for the missing file 509. This improvement further reduces the amount of download time and bandwidth required to retrieve an upgrade. By using this on-demand install feature, downloading certain components may be deferred until they are actually used.

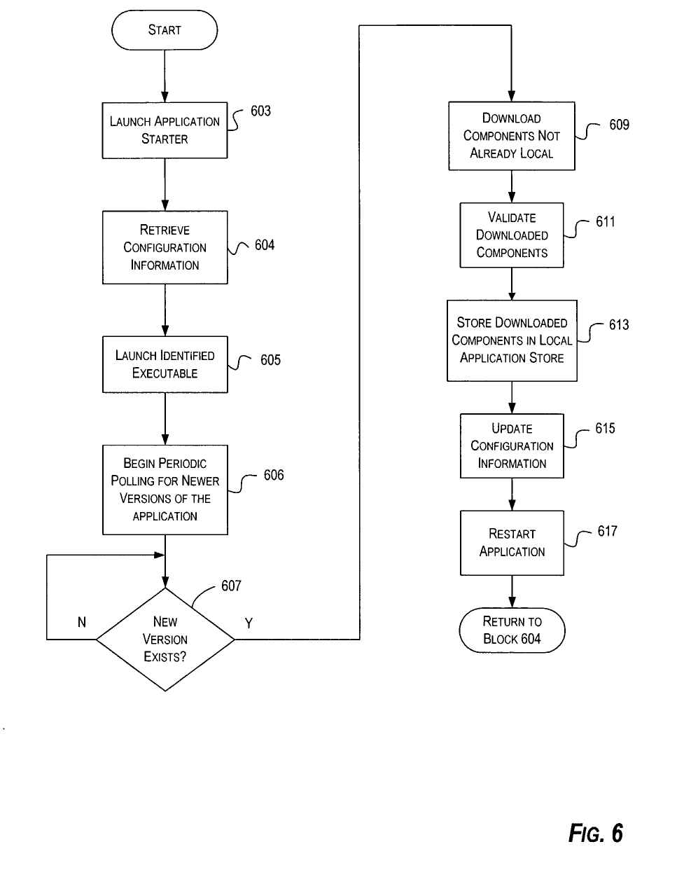

FIG. 6 is a logical flow diagram generally illustrating a process for retrieving an upgrade for an application installed on a client computer. The upgrade is being made available over a network. The process begins where a user has launched an application by activating a shortcut to the application. In accordance with the invention, the shortcut points to an application starter component associated with the application. The process enters at block 603, where the application starter component has been launched and proceeds to block 604.

At block 604, the application starter component retrieves configuration information about the application. The configuration information may be stored in a starter configuration file associated with the application. The configuration information includes an identifier for a current version of the application, and a name of an executable component for the current version. At block 605, the application starter component launches the identified executable component.

At block 606, an application updater component begins periodically polling for newer versions of the application. The application updater component may be configured to query a remote server to determine whether the newer version exists. The application updater component may issue the query using a Web service, or any other acceptable mechanism for issuing remote messages.

At decision block 607, the process iteratively repeats polling the server at some predetermined time interval or based on some other timing frequency until a new version is found. When a new version is found, the process proceeds to block 609.

At block 609, the components of the new version of the application are downloaded. It will be appreciated that as part of the download process, a description of each component may be compared to descriptions of each component already stored locally and any component that is already stored locally may be omitted from the download.

At block 611, once the application components are downloaded, the application updater component may validate any public keys or signatures associated with the components to authenticate them and commit the application components to the application store 109. Alternatively, certain components may be identified for download on-demand, rather than immediately.

At block 613, the downloaded components are stored in a local application store. The components are stored in their own location separate from the current version of the application. Shared components may be stored in a global or system cache to be made available to multiple applications.

At block 615, the configuration information is updated to reflect the new version of the application. As described above, the configuration information identifies the current version of the application, and identifies the executable file associated with the current version. Accordingly, the configuration information is updated to reflect those aspects of the downloaded version of the application. In this way, on a subsequent launch of the application, the application starter component will launch the executable component associated with the current version. It will be appreciated that earlier versions of the application may be periodically eliminated.

At block 617, the application is restarted, and the process may return to block 604, described above. It should be appreciated that, in accordance with the invention, the application need not be restarted immediately. Rather, the user may continue operating with the existing version of the application until such time as the user would normally terminate the application. In that case, the new version of the application would be launched on the next execution of the application by the application starter component. Alternatively, the user may be prompted whether the user desires to begin using the newer version of the application immediately. Either scenario is acceptable.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A computer-readable medium encoded with computer-executable instructions for upgrading an application, comprising:
issuing a query to determine whether a newer version of an installed application is available for download;
if so, downloading components associated with the newer version of the application to a local data store, each component being sufficiently self-described to distinguish each component from other components; and
modifying configuration information associated with the installed application so that the newer version of the application is executed upon a subsequent launch of the application.

2. The computer-readable medium of claim 1, further comprising, prior to issuing the query, receiving a notification of an initial launch of the installed application at an application starter component.

3. The computer-readable medium of claim 2, wherein the application starter component performs the step of issuing the query.

4. The computer-readable medium of claim 3, wherein the application starter component performs the step of downloading the components associated with the newer version of the application.

5. The computer-readable medium of claim 2, wherein the application starter component executes the newer version of the application based on the modified configuration information.

6. The computer-readable medium of claim 1, wherein modifying the configuration information comprises adding a reference to a configuration file that identifies the newer version of the application.

7. The computer-readable medium of claim 6, wherein modifying the configuration information further comprises adding an identification of an executable file associated with the newer version of the application.

8. The computer-readable medium of claim 1, wherein downloading the components of the newer version of the application comprises verifying that the components are authentic using a public key associated with a publisher of the components.

9. The computer-readable medium of claim 8, wherein verifying that the components are authentic comprises downloading a list of public keys that are valid for the components of the newer version of the application.

10. The computer-readable medium of claim 9, wherein verifying that the components are authentic further comprises downloading a list of files which can be excluded from the verification.

11. A computer-executable method for upgrading an application from a remote storage location, comprising:
receiving a notification of a launch of the application at an application starter component, the application starter component having associated configuration information;
launching an executable file identified in the configuration information;
polling the remote storage location to determine if a newer version of the application is available for download;
if so, downloading the newer version of the application to a local storage; and
updating the configuration information to identify the newer version of the application so that, upon a subsequent launch notification, the newer version of the application is executed.

12. The computer-executable method of claim 11, further comprising determining if any components of the newer version of the application already exist on the local storage, and if so, limiting the download of the components of the newer version of the application to those that do not already exist.

13. The computer-executable method of claim 11, wherein the configuration information comprises an identification of a current version of the application.

14. The computer-executable method of claim 13, wherein the configuration information further comprises a name of the executable file.

15. The computer-executable method of claim 11, wherein polling the remote storage location comprises issuing a message using a Web service to make the determination by an updater component.

16. The computer-executable method of claim 15, wherein issuing the message using the Web service comprises causing a remote procedure to be executed on a server, the remote procedure being operative to determine whether the newer version of the application is available.

17. The computer-executable method of claim 11, wherein the newer version of the application is downloaded to a location separate from the existing version of the application.

18. The computer-executable method of claim 11, wherein downloading the newer version of the application comprises verifying that the components of the newer version of the application are authentic using a public key associated with a publisher of the application.

19. The computer-executable method of claim 18, wherein verifying that the components are authentic comprises downloading a list of public keys that are valid for the components of the newer version of the application.

20. The computer-executable method of claim 19, wherein verifying that the components are authentic further comprises downloading a list of files which can be excluded from the verification.

21. A computer-readable medium encoded with computer-executable components, comprising:
a current version of an application including at least one executable component;
a starter configuration component identifying the current version of the application and the executable component associated with the current version of the application;
an application starter component configured to read the starter configuration component and to cause the identified executable component to be executed; and
an application updater component configured to poll a remote location to determine if a newer version of the application is available for download.

22. The computer-readable medium of claim 21, wherein the application updater component is further configured to retrieve the newer version of the application if available.

23. The computer-readable medium of claim 22, wherein the application updater component is further configured to store the newer version of the application in a location separate from the current version on local storage.

24. The computer-readable medium of claim 23, wherein the application updater component is further configured to update the starter configuration component to reflect the newer version of the application so that the application starter component causes an executable component associated with the newer version of the application to be executed.
